(19) United States
(12) Patent Application Publication
(10) Pub. No.: US 2013/0178964 A1
(43) Pub. Date: Jul. 11, 2013

(54) AUDIO SYSTEM WITH ADAPTABLE AUDIO OUTPUT

(71) Applicant: Oliver Bergmann, Kentfield, CA (US)

(72) Inventor: Oliver Bergmann, Kentfield, CA (US)

(21) Appl. No.: 13/345,715

(22) Filed: Jan. 8, 2012

(51) Int. Cl. G06F 17/00

(52) U.S. Cl. 700/94

(57) ABSTRACT

Methods for operating a digital music server with adaptable equalization based on an identification of key instruments within an audio recording and with adaptable audio output based on an identification of one or more speakers in communication with the digital music server are described. In some embodiments, the digital music server may determine an audio category associated with the audio recording, acquire an audio enhancement filter associated with the audio category, generate an audio signal from the audio recording, identify one or more key instruments within the audio signal, update the audio enhancement filter based on the one or more key instruments, and generate an enhanced audio signal using the audio enhancement filter. The audio enhancement filter may be combined with a speaker compensation filter in order to compensate for variations in the frequency response of a particular speaker due to temperature and speaker lifetime.

### BACKGROUND

Digital music players may store and play numerous digital audio recordings. A digital audio recording may include digital values representing amplitudes of a sampled audio signal at time intervals associated with a particular sampling rate. In some cases, the digital values may comprise pulse-code modulation (PCM) data values in which each of the digital values corresponds with a quantized digital value within a range of digital steps (e.g., the digital value may be represented as a 16-bit or 24-bit data value). Two properties that determine the fidelity of the PCM data to the original audio signal include the sampling rate (i.e., the number of times per second that samples are taken) and the audio bit depth (i.e., the number of bits of information recorded for each sample). Some high-resolution audio recordings may be generated using a sampling rate of 192 kHz and an audio bit depth of 24.

In order to hear a given digital audio recording, the digital values must be converted to an analog form and applied to an audio output device such as a loudspeaker or headphones. The digital to analog conversion is typically accomplished using a digital-to-analog converter (DAC). In some cases, the digital values may be modified via equalization prior to being converted into an analog form. Equalization is a process that alters the frequency response of a digital audio signal and may include an increase or decrease in audio signal strength for a portion of (or band of) audio frequencies. Equalization may be implemented by loading an equalization filter comprising one or more equalization filter coefficients into an audio signal processor or a digital signal processor (DSP). As the full range of human hearing is roughly between 20 Hz and 20 kHz, many audio processing chips (e.g., the TAS3103 Digital Audio Processor or the TLC320AD81C Stereo Audio Digital Equalizer DAC from Texas Instruments) provide the ability to modify a number of predetermined audio frequency bands between 20 Hz and 20 kHz. Thus, an audio processing chip with equalization capability may be used adjust or customize the audio signal strengths associated with a number of audio frequencies including low (e.g., bass), middle (e.g., mid), and high (e.g., treble) audio frequencies.

### BRIEF DESCRIPTION OF THE DRAWINGS

FIG. 1 depicts one embodiment of a networked computing environment in which the disclosed technology may be practiced.

FIG. 2 depicts one embodiment of an audio server.

FIG. 3 depicts an alternative embodiment of an audio server.

FIG. 4 depicts one embodiment of a remote equalizer.

FIG. 5 is a flowchart describing one embodiment of a process for generating an enhanced audio signal using a consolidated equalization filter.

FIG. 6 is a flowchart describing one embodiment of a process for determining an audio category.

FIG. 7 is a flowchart describing one embodiment of a process for generating a consolidated equalization filter.

FIG. 8 is a flowchart describing an alternative embodiment of a process for generating an enhanced audio signal using a consolidated equalization filter.

FIG. 9 is a flowchart describing one embodiment of a process for generating an enhanced audio signal based on the identification of one or more speakers in communication with an audio device.

FIG. 10 is a flowchart describing another embodiment of a process for generating an enhanced audio signal based on the identification of one or more speakers in communication with an audio device.

FIG. 11 depicts one embodiment of a mobile audio server.

### DETAILED DESCRIPTION

Technology is described for operating a digital music server with adaptable equalization based on an identification of key instruments within an audio recording and with adaptable audio output based on an identification of one or more speakers in communication with the digital music server. In some embodiments, the digital music server may determine an audio category associated with the audio recording, acquire an audio enhancement filter associated with the audio category, generate an audio signal from the audio recording, identify one or more key instruments within the audio signal, update the audio enhancement filter based on the one or more key instruments, and generate an enhanced audio signal using the audio enhancement filter. The audio enhancement filter may be combined with a speaker compensation filter in order to compensate for variations in the frequency response of a particular speaker due to temperature and speaker lifetime.

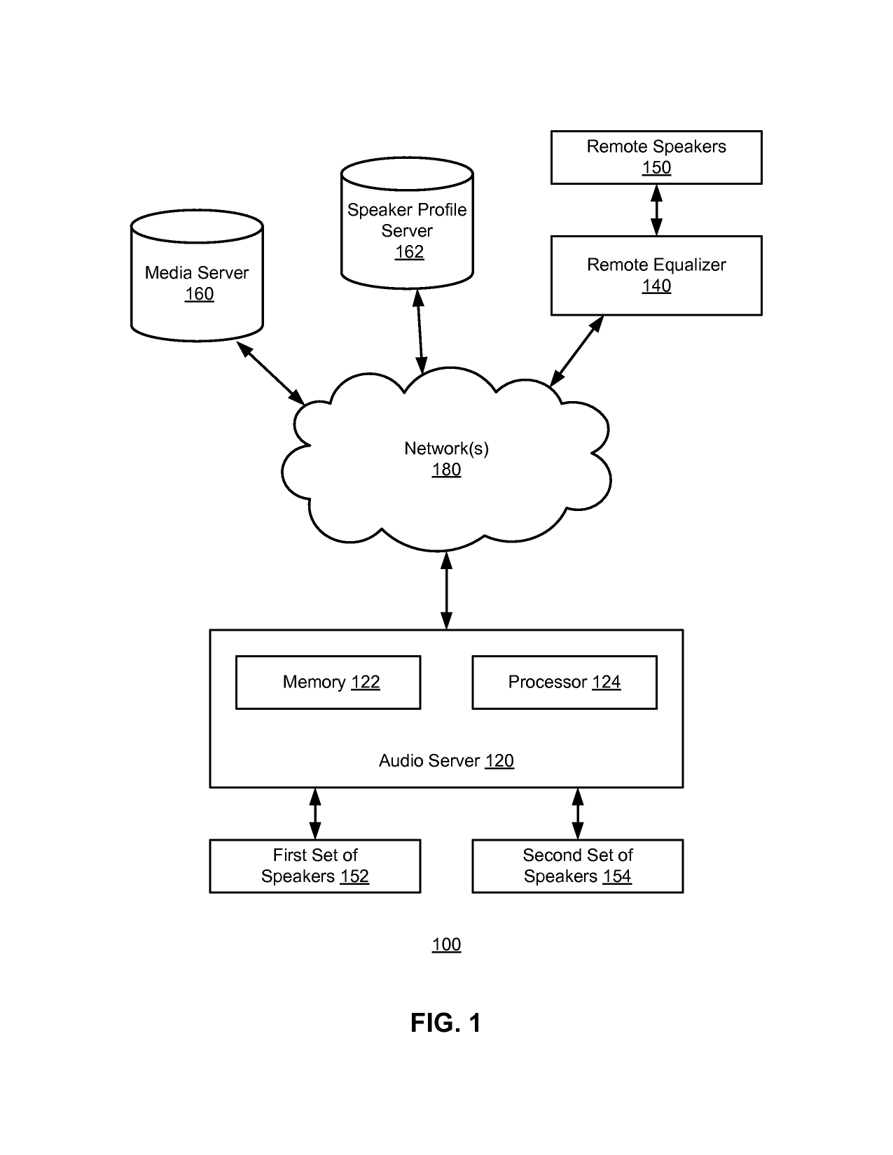

FIG. 1 depicts one embodiment of a networked computing environment 100 in which the disclosed technology may be practiced. Networked computing environment 100 includes a plurality of computing devices interconnected through one or more networks 180. The one or more networks 180 allow a particular computing device to connect to and communicate with another computing device. In some embodiments, the plurality of computing devices may include other computing devices not shown. In some embodiments, the plurality of computing devices may include more than or less than the number of computing devices shown in FIG. 1. The one or more networks 180 may include a secure network such as an enterprise private network, an unsecure network such as a wireless open network, a cellular network, a local area network (LAN), a wide area network (WAN), and the Internet. Each network of the one or more networks 180 may include hubs, bridges, routers, switches, and wired transmission media such as a wired network or direct-wired connection.

As depicted, the plurality of computing devices includes audio server 120, media server 160, speaker profiles server 162, and remote equalizer 140. The audio server 120 is in communication with a first set of speakers 152 and a second set of speakers 154 via one or more wired or wireless connections. The audio server 120 may comprise a mobile or non-mobile computing device. The audio server 120 includes memory 122 for storing one or more audio files (including high-resolution audio files), metadata associated with each of the one or more audio files (e.g., title, artist, and genre associated with each audio file), and computer readable instructions. Memory 122 may include one or more storage devices (or storage components). The one or more storage devices may comprise non-volatile memory (e.g., NAND Flash) and/or volatile memory (e.g., SRAM or DRAM). The one or more storage devices may include long-term data storage such as a hard drive and/or short-term data storage such as a memory buffer. In some embodiments, memory 122 may buffer and/or store one or more media files received from media server 160. The audio server 120 also includes processor 124 for executing the computer readable instructions stored in memory 122 in order to perform processes described herein. The audio server 120 may transmit one or more audio streams via a wired or wireless interface to a remote computing device, such as remote equalizer 140.

The speaker profiles server 162 may store a large library of different speaker profiles with each of the different speaker profiles indexed by a particular speaker identifier. Each speaker profile may be associated with a speaker compensation filter. In some cases, the particular speaker identifier may correspond with a speaker module that includes more than one speaker (i.e., the speaker profile or speaker compensation filter associated with the speaker module covers the combination of the more than one speaker included within the speaker module).

The first set of speakers 152 may comprise a first set of one or more audio speakers (e.g., a first group of speakers within a home office or family room environment). The second set of speakers 154 may comprise a second set of one or more audio speakers (e.g., a second group of speakers associated with an environment different from the first group of speakers). The remote equalizer 140 is in communication with remote speakers 150. The remote speakers 150 may comprise one or more audio speakers within a remote environment such as a car or work office environment. In one embodiment, the audio server 120 generates one or more enhanced audio signals using an audio enhancement filter and transmits the one or more enhanced audio signals to the remote equalizer 140. The remote equalizer 140 then generates one or more compensated audio signals using a speaker compensation filter and outputs the one or more compensated audio signals to the remote speakers 150.

A server, such as media server 160, may allow a client to download information (e.g., text, audio, image, and video files) from the server or to perform a search query related to particular information stored on the server. In general, a “server” may include a hardware device that acts as the host in a client-server relationship or a software process that shares a resource with or performs work for one or more clients. Communication between computing devices in a client-server relationship may be initiated by a client sending a request to the server asking for access to a particular resource or for particular work to be performed. The server may subsequently perform the actions requested and send a response back to the client.

Networked computing environment 100 may provide a cloud computing environment for one or more computing devices. Cloud computing refers to Internet-based computing, wherein shared resources, software, and/or information are provided to one or more computing devices on-demand via the Internet (or other global network). The term “cloud” is used as a metaphor for the Internet, based on the cloud drawings used in computer network diagrams to depict the Internet as an abstraction of the underlying infrastructure it represents.

In some embodiments, audio server 120 may receive an audio file from media server 160, buffer the audio file, decode the audio file (e.g., using an MP3 or MP4 decoder), apply audio signal processing techniques to one or more decoded audio signals, and transmit one or more enhanced audio signals based on the one or more decoded audio signals to the first set of speakers 152 and the second set of speakers 154. The audio signal processing techniques may include equalization of one or more audio signals associated with the audio file or other signal processing techniques that modify (e.g., increase or decrease) the audio signal strength for a portion of (or band of) audio frequencies associated with the one or more audio signals. Other audio signal processing techniques such as noise cancellation and echo removal may also be applied to the one or more decoded audio signals.

In one embodiment, one or more equalization filter coefficients and an input audio signal are provided to an audio signal processing element in order to generate an enhanced audio signal based on the one or more equalization filter coefficients. The one or more equalization filter coefficients may be based on the content of the audio recording from which the input audio signal is generated. The one or more equalization filter coefficients may be determined by identifying an audio category (e.g., a genre such as jazz, rock lite, rock heavy, or classical) associated with the audio recording, acquiring a predetermined set of equalization filter coefficients associated with the audio category, identifying one or more sounds associated with one or more key instruments (e.g., a guitar, piano, or tuba) within the input audio signal, and modifying the set of equalization filter coefficients based on the one or more key instruments in order to create the one or more equalization filter coefficients for generating the enhanced audio signal. The process of generating the one or more equalization filter coefficients may be performed on-the-fly as the audio server 120 is streaming the enhanced audio signal to the first set of speakers 152 and the second set of speakers 154.

In one embodiment, the audio server 120 may receive a first speaker compensation filter associated with the first set of speakers 152 and a second speaker compensation filter associated with the second set of speakers 154 from a speaker profiles server, such as speaker profiles server 162. The first speaker compensation filter may include a first set of speaker coefficients. The first set of speaker coefficients may represent an inverse frequency response associated with the first set of speakers 152. In some cases, the first set of speaker coefficients may attempt to flatten the frequency response of the first set of speakers 152. The first set of speakers 152 may comprise a speaker unit (or module) including a woofer, a mid-range speaker, and a tweeter. The second speaker compensation filter may include a second set of speaker coefficients. The second set of speaker coefficients may represent an inverse frequency response associated with the second set of speakers 154. The second set of speakers 154 may comprise a second speaker unit including a woofer, a mid-range speaker, and a tweeter.

In some cases, the audio server 120 may consolidate one or more equalization filter coefficients and the first set of speaker coefficients into a first consolidated set of filter coefficients. In one example, the first consolidated set of filter coefficients may comprise five different coefficients with each of the five different coefficients associated with a particular audio frequency band or center frequency (e.g., the five center frequencies may correspond with 62.5 Hz, 250 Hz, 1 kHz, 4 kHz, and 16 kHz). The audio server 120 may also consolidate the one or more equalization filter coefficients and the second set of speaker coefficients into a second consolidated set of filter coefficients. The audio server 120 may subsequently generate a first audio stream based on an audio file stored locally on the audio server 120 and the first consolidated set of filter coefficients and generate a second audio stream based on the audio file and the second consolidated set of filter coefficients. In one embodiment, the audio server 120 may modify both the first consolidated set of filter coefficients and the second consolidated set of filter coefficients on-the-fly as one or more key instruments are identified within the first audio stream or the second audio stream. Therefore, the first audio stream may be enhanced on-the-fly and customized to the first set of speakers 152 and the second audio stream may be enhanced on-the-fly and customized to the second set of speakers 154.

In some embodiments, a set of speaker coefficients associated with a particular set of speakers may be a function of a temperature of the particular set of speakers. The set of speaker coefficients may also be a function of a lifetime (or age) of the particular set of speakers (e.g., in order to compensate for burn-in of the particular set of speakers). Temperature information and speaker lifetime information associated with the particular set of speakers may be communicated to the audio server 120 from the particular set of speakers. The temperature information and the speaker lifetime information may also be indirectly determined by the audio server 120. In one example, the audio server 120 includes a temperature sensor for determining a temperature associated with a particular set of speakers within the same room as the audio server 120. The audio server 120 may also identify each speaker of the particular set of speakers and may track the speaker lifetime of each speaker.

In some embodiments, audio server 120 may adapt the audio signals outputted from the audio server 120 based on an identification of one or more speakers in communication with the audio server 120. In one example, if the first set of speakers 152 includes only a single speaker (or speaker unit), then the audio signals sent to the first set of speakers 152 may comprise a mono audio signal. In another example, if the first set of speakers includes two or more speakers (e.g., two different speaker units), then the audio signals sent to the first set of speakers may comprise stereo audio signals. If the first set of speakers includes more than two speakers associated with a surround sound system, then the audio signals sent to the first set of speakers may comprise audio signals associated with a surround sound configuration (e.g., 5.1 surround sound or 7.1 surround sound). In some cases, the audio signals outputted from the audio server 120 may be automatically adapted as one or more speakers of the particular set of speakers are added to or removed from the particular set of speakers (e.g., due to speaker upgrades or due to the unplugging of the audio server from a first set of speakers associated with a home environment and the plugging of the audio server into a second set of speaker associated with a car).

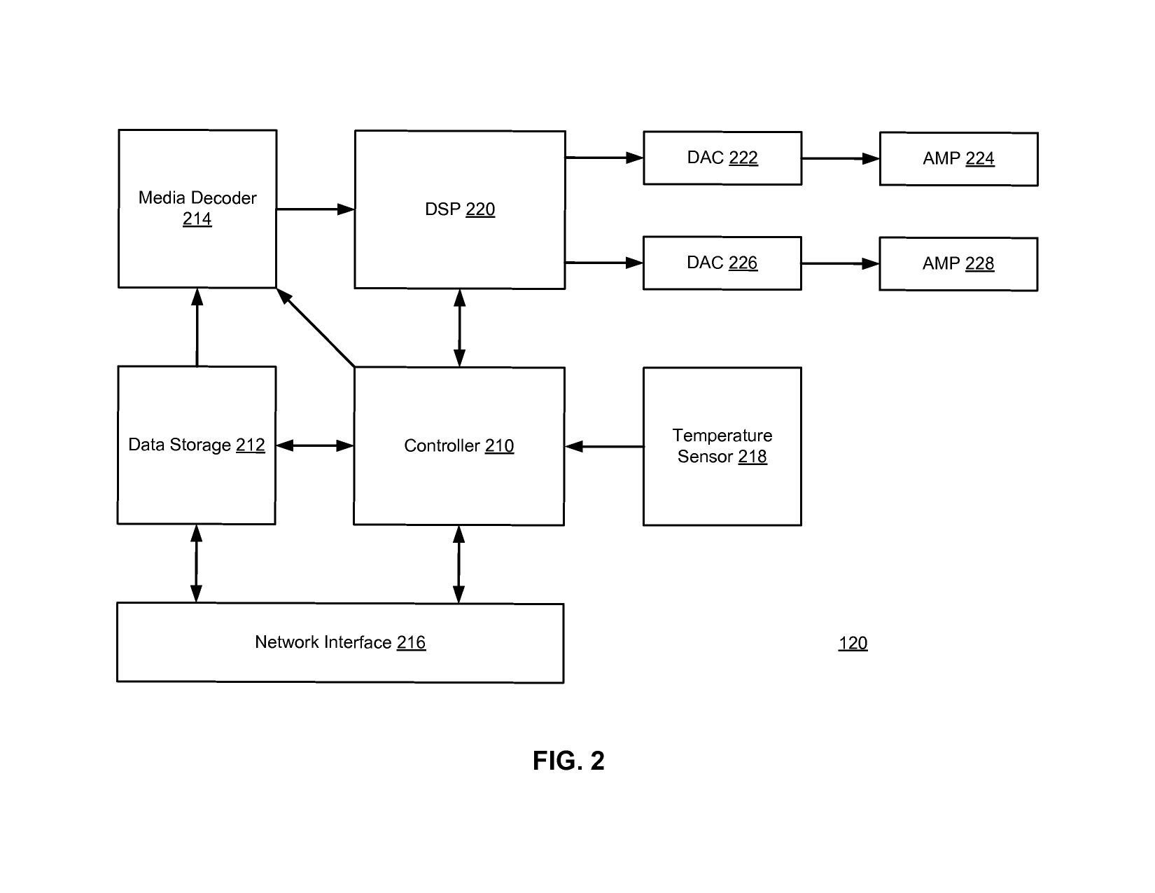

FIG. 2 depicts one embodiment of audio server 120 of FIG. 1. As depicted, audio server 120 includes a controller 210 in communication with a network interface 216, data storage 212, temperature sensor 218, media decoder 214, and digital signal processor (DSP) 220. Data storage 212 is in communication with network interface 216, controller 210, and media decoder 214. DSP 220 is in communication with media decoder 214, controller 210, digital to analog converter (DAC) 222, and digital to analog converter (DAC) 226. DAC 222 drives amplifier (AMP) 224 and DAC 226 drives amplifier (AMP) 228. In some cases, one or more of the components depicted in FIG. 2 may be integrated on a single chip. For example, DSP 220 and DAC 222 may be integrated on a single chip. In some cases, the audio signal processing capability of DSP 220 may be integrated into a DAC with signal processing capability.

In one embodiment, an audio file may be received at network interface 216 and stored or buffered in data storage 212. The audio file may be associated with a particular encoded format (e.g., MP3 or MP4) which may be decoded by media decoder 214. The output of the media decoder 214 may comprise one or more audio signals associated with the audio file. In the case of stereo audio signals, the one or more audio signals may comprise a left audio signal and a right audio signal. The one or more audio signals may be processed by DSP 220 in order to generate one or more enhanced audio signals based on the one or more audio signals and one or more equalization filter coefficients generated by controller 210. Other audio signal processing techniques (e.g., noise cancellation or echo removal) may also be applied to the one or more audio signals by DSP 220.

In one embodiment, one or more equalization filter coefficients are provided to DSP 220 by controller 210 and stored in a configuration register within DSP 220. The one or more equalization filter coefficients are used by DSP 220 in order to modify particular audio frequency bands associated with the one or more audio signals outputted from media decoder 214. DSP 220 outputs one or more enhanced audio signals based on the one or more equalization filter coefficients. Each of the one or more enhanced audio signals may be used to drive a digital to analog converter associated with a particular audio output channel. In the case of stereo audio outputs, DSP 220 will generate a left enhanced audio signal and a right enhanced audio signal. Amplifiers 224 and 228 will amplify the outputs of digital to analog converters 222 and 226, respectively, in order to drive one or more speakers connected to the amplifiers.

The one or more equalization filter coefficients generated by controller 210 may be based on the content of the audio file. The content of the audio file may be used to identify a corresponding audio category. In one example, metadata associated with the audio file is used to identify the audio category associated with the audio file. The metadata may include a genre (e.g., classical music), a subgenre (e.g., Baroque classical music), an artist (e.g., Bach), or a title associated with the audio file. A lookup table may be used to map the audio category identified to a predetermined set of equalization filter coefficients. The one or more equalization filter coefficients may comprise modified coefficient values based on the predetermined set of equalization filter coefficients and the detection of particular sounds or instruments within one or more audio signals generated from the audio file.

In one embodiment, controller 210 may generate one or more audio signals based on the audio file stored in data storage 212 and identify one or more sounds associated with one or more key instruments within one or more audio signals. The one or more key instruments may be detected by using sound pattern matching techniques. In another embodiment, controller 210 may identify the one or more key instruments by analyzing one or more enhanced audio signals outputted from DSP 220. The process of generating and/or modifying the one or more equalization filter coefficients may be performed on-the-fly as the audio server 120 is streaming the enhanced audio signals to one or more speakers connected to amplifiers 224 and 228.

In some embodiment, the controller 210 may generate the one or more equalization filter coefficients by consolidating a first set of audio enhancement coefficients and a second set of speaker compensation coefficients. In this case, the one or more equalization filter coefficients may comprise a single consolidated set of equalization filter coefficients. The controller 210 may modify the second set of speaker compensation coefficients based on temperature information received from temperature sensor 218. The controller 210 may also modify the second set of speaker compensation coefficients based on speaker lifetime information received from one or more speakers in communication with audio server 120 via the network interface 216.

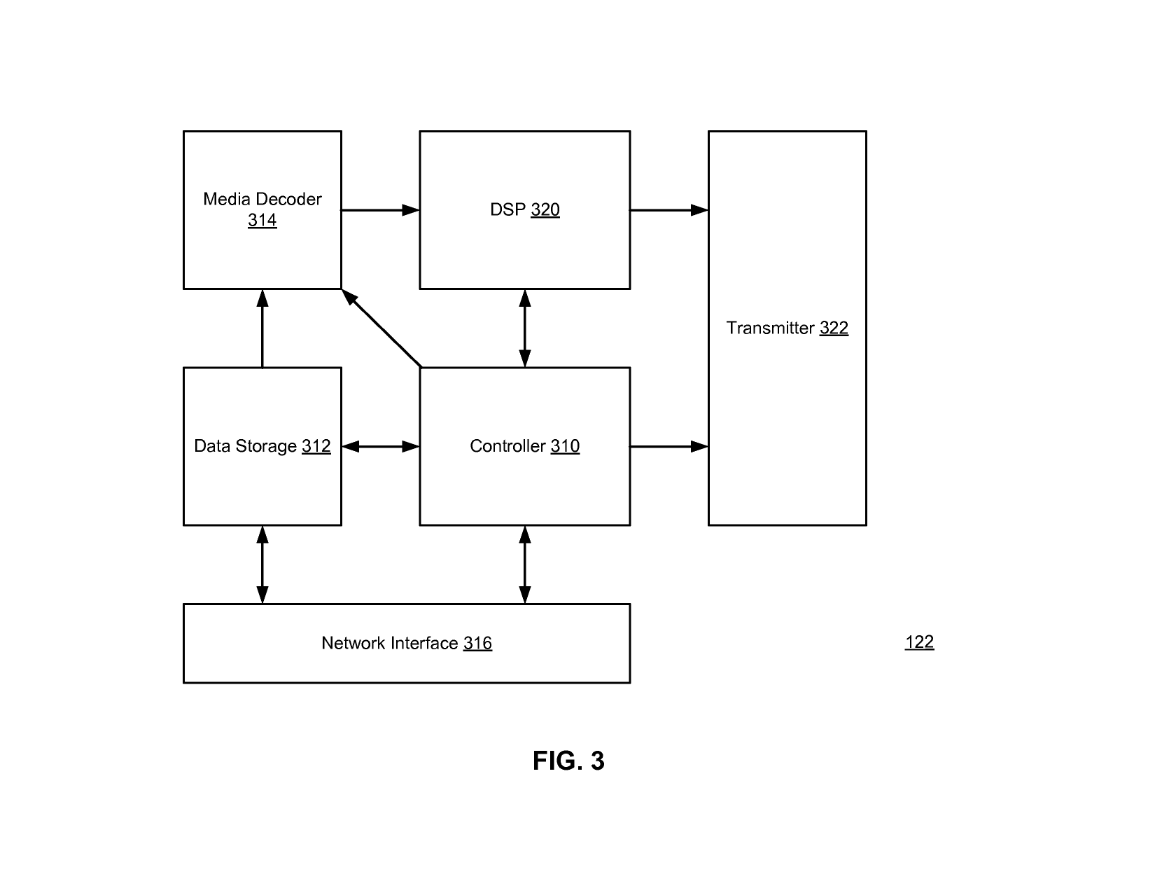

FIG. 3 depicts one embodiment of an audio server 122, which is one example of an implementation for audio server 120 in FIG. 1. As depicted, audio server 122 includes a controller 310 in communication with a network interface 316, data storage 312, media decoder 314, digital signal processor (DSP) 320, and transmitter 322. Data storage 312 is in communication with network interface 316, controller 310, and media decoder 314. DSP 320 is in communication with media decoder 314, controller 310, and transmitter 322. In some cases, one or more of the components depicted in FIG. 3 may be integrated on a single chip. For example, DSP 320 and controller 310 may be integrated on a single chip.

In one embodiment, an audio file may be received at network interface 316 and stored in data storage 312. The audio file may be associated with a particular encoded format (e.g., MP3 or MP4) which may be decoded by media decoder 314. The output of the media decoder 314 may comprise one or more audio signals associated with the audio file. In the case of stereo audio signals, the one or more audio signals may comprise a left audio signal and a right audio signal. The one or more audio signals may be processed by DSP 320 in order to generate one or more enhanced audio signals based on the one or more audio signals and one or more equalization filter coefficients generated by controller 310. Other audio signal processing techniques (e.g., noise cancellation or echo removal) may also be applied to the one or more audio signals by DSP 320. The one or more enhanced audio signals generated by DSP 320 may be transmitted to one or more remote computing devices, such as remote equalizer 140 in FIG. 1, via transmitter 322.

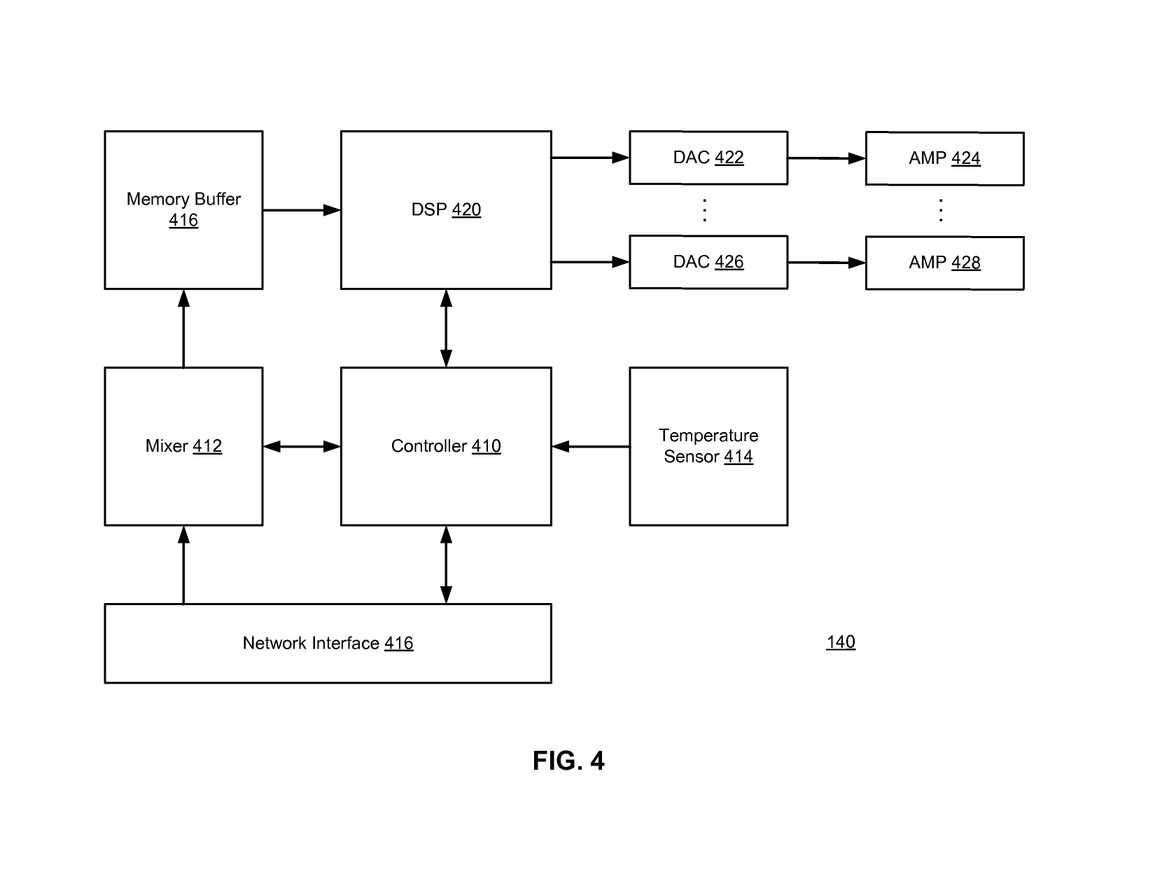

FIG. 4 depicts one embodiment of remote equalizer 140 of FIG. 1. As depicted, remote equalizer 140 includes a controller 410 in communication with a network interface 416, mixer 412, memory buffer 416, digital signal processor (DSP) 420, and temperature sensor 414. Mixer 412 is in communication with network interface 416, controller 410, and memory buffer 416. Mixer 412 may comprise a programmable audio mixer in which one or more input audio signals from network interface 416 may be combined or otherwise mixed into one or more output channels. DSP 420 is in communication with memory buffer 416, controller 410, digital to analog converter (DAC) 422, and digital to analog converter (DAC) 426. DAC 422 drives amplifier (AMP) 424 and DAC 426 drives amplifier (AMP) 428. In some cases, one or more of the components depicted in FIG. 4 may be integrated on a single chip. For example, DSP 420 and DAC 422 may be integrated on a single chip.

In some embodiments, controller 410 may identify one or more speakers in communication with amplifiers 424 and 428. In one embodiment, controller 410 may determine the number of and types of speakers associated with the one or more speakers by receiving speaker identification information from each of the one or more speakers (e.g., via network interface 416 or another feedback channel not shown). In some cases, the speaker identification information may be received by controller 410 via network interface 416 upon an identification request from controller 410. Based on speaker identification information, controller 410 may load a configuration vector into mixer 412 in order to configure the audio signals outputted from mixer 412. In one example, if the one or more speakers include only a single speaker (or speaker unit), then mixer 412 will combine one or more audio signals into a mono audio signal. In another example, if the one or more speakers include two or more speakers (e.g., two different speaker units), then mixer 412 may allow the one or more audio signals to pass through to DSP 420 without mixing.

In some embodiments, the one or more audio signals output from mixer 412 may be buffered in memory buffer 416 and processed by DSP 420 in order to generate one or more compensated audio signals based on the one or more audio signals and a set of speaker compensation coefficients generated by controller 410. Other audio signal processing techniques (e.g., noise cancellation or echo removal) may also be applied to the one or more audio signals by DSP 420. In one embodiment, the set of speaker compensation coefficients may be determined based on the speaker identification information used by controller 410 in order to determine the configuration vector for mixer 412. As such, the speaker identification information may be reused by controller 410 in order to determine one or more sets of speaker compensation coefficients, with each set of the one or more sets of speaker compensation coefficients associated with a different speaker of the one or more speakers. In one example, controller 410 may acquire a predetermined speaker profile associated with a particular type of speaker (e.g., a KEF Q100 speaker) including a set of speaker compensation coefficients. The controller 410 may also acquire temperature information from temperature sensor 414 and adjust the set of speaker compensation coefficients based on the temperature information. The controller 410 may also determine one or more speaker lifetimes associated with the one or more speakers driven by amplifiers 424 and 428. The temperature information and the speaker lifetime information may both be used by controller 410 in order to determine and/or modify the set of speaker compensation coefficients for each of the one or more speakers.

In one embodiment, the remote equalizer 140 may acquire a first speaker compensation filter associated with a first set of speakers driven by amplifier 424 and acquire a second speaker compensation filter associated with a second set of speakers driven by amplifier 428 from a speaker profiles server, such as speaker profiles server 162 in FIG. 1. The first speaker compensation filter may include a first set of speaker coefficients. The second speaker compensation filter may include a second set of speaker coefficients. The one or more audio signals outputted from mixer 412 may be processed by DSP 420 in order to generate a first set of compensated audio signals based on the one or more audio signals and the first set of speaker coefficients and to generate a second set of compensated audio signals based on the one or more audio signals and the second set of speaker coefficients. In some cases, both the first set of speaker coefficients and the second set of speaker coefficients may be provided to DSP 420 by controller 410 and stored in configuration registers within DSP 420. The DSP 420 may use parallel processing cores in order to generate the first set of compensated audio signals and the second set of compensated audio signals in parallel.

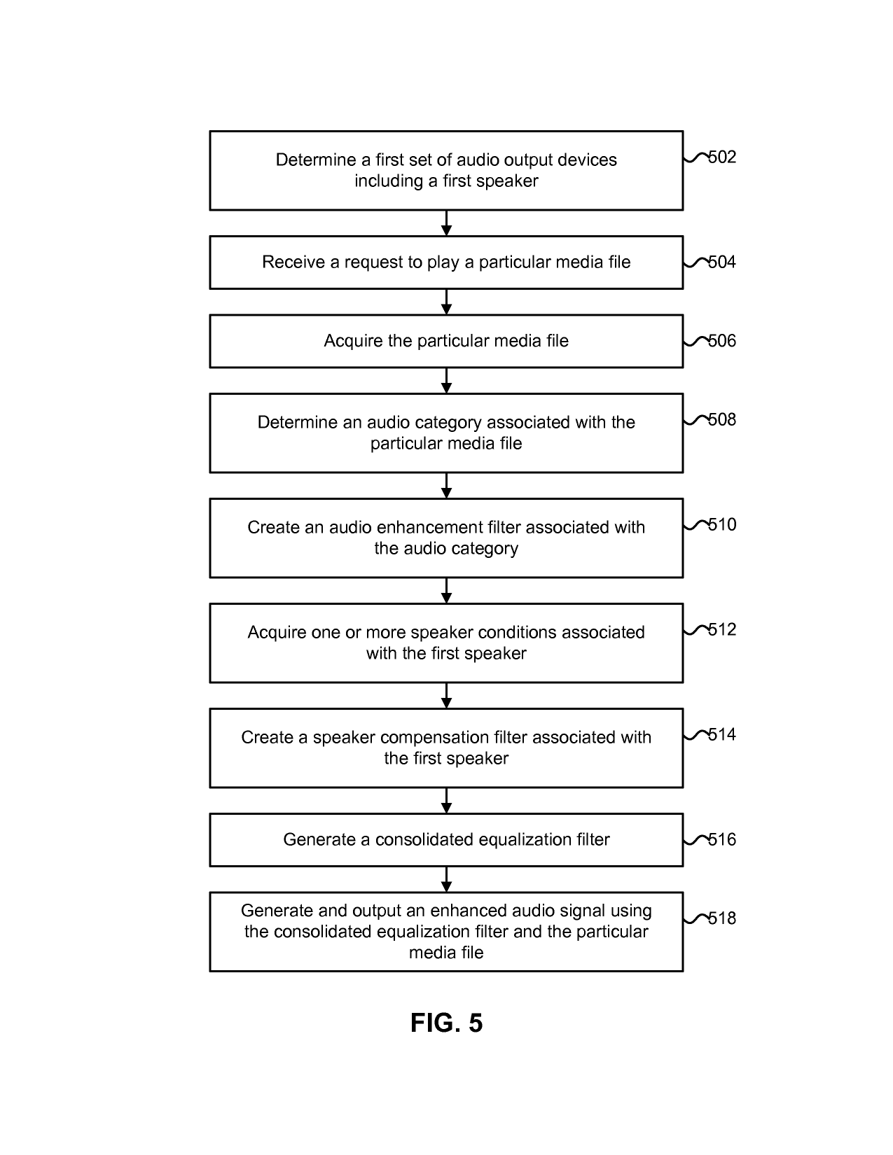

FIG. 5 is a flowchart describing one embodiment of a process for generating an enhanced audio signal using a consolidated equalization filter. In one embodiment, the process of FIG. 5 is performed by an audio server, such as audio server 120 in FIG. 1.

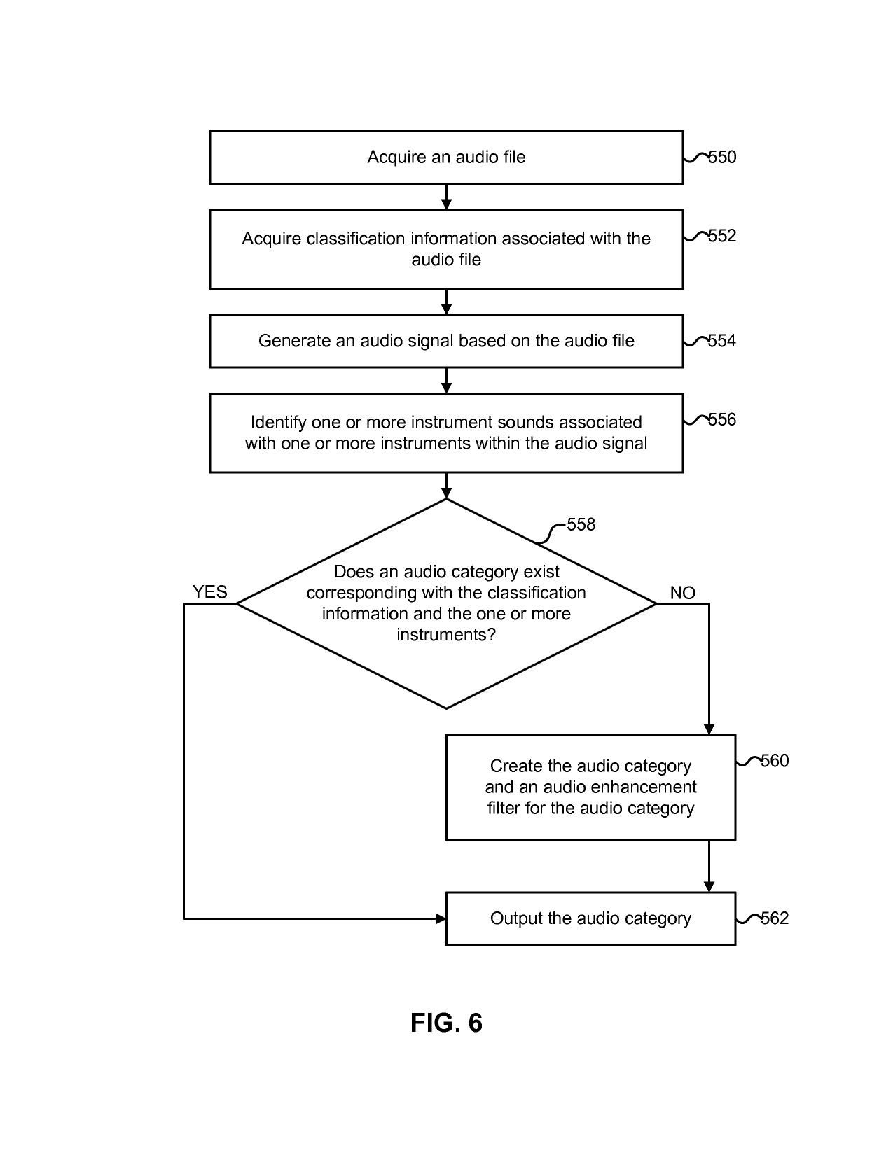

In step 502, a first set of audio output devices including a first speaker is determined. The first speaker may comprise a loudspeaker. In one embodiment, the first set of audio output devices may be determined by identifying one or more audio devices in communication with an audio server or otherwise connected to the audio server. In step 504, a request to play a particular media file is received. The particular media file may comprise an audio file. In step 506, the particular media file is acquired. The particular media file may be acquired from a media server, such as media server 160 in FIG. 1. In step 508, an audio category associated with the particular media file is determined. The audio category may comprise a particular music genre. In one embodiment, the audio category may be determined using metadata associated with the particular media file. One embodiment of a process for determining an audio category is described later in reference to FIG. 6. In some cases, the audio category may correspond with a particular genre and the identification of one or more instruments detected within audio signals generated from the particular media file. For example, the audio category may comprise “classical music with a harpsichord” or “pop music with a trumpet.” The one or more instruments may be detected by applying audio pattern matching techniques to one or more audio signals generated from the particular media file.

In step 510, an audio enhancement filter associated with the audio category is created. The audio enhancement filter may include one or more audio enhancement coefficients for modifying the frequency response of a digital audio signal. In one embodiment, the one or more audio enhancement coefficients may be adjusted on-the-fly as one or more instruments are detected within one or more audio signals associated with the particular media file. For example, a classical music piece may utilize a piano during a first time period and a harpsichord during a second time period subsequent to the first time period. During the first time period, the one or more audio enhancement coefficients may be generated in order to enhance audio frequencies associated with the piano. During the second time period, the one or more audio enhancement coefficients may be generated in order to enhance audio frequencies associated with the harpsichord. In some cases, the audio enhancement filter may be modified or customized by an end user of an audio server, such as audio server 120 in FIG. 1.

In step 512, one or more speaker conditions associated with the first speaker are acquired. The one or more speaker conditions may include temperature information associated with the first speaker, speaker lifetime information associated with the first speaker, and/or acoustic environment information associated with the first speaker (e.g., the first speaker exists in a large open space or in an enclosed car). In step 514, a speaker compensation filter associated with the first speaker is created. The speaker compensation filter may include one or more speaker compensation coefficients for modifying the frequency response of a digital audio signal. The one or more speaker compensation coefficients may be adjusted based on the one or more speaker conditions acquired in step 512.

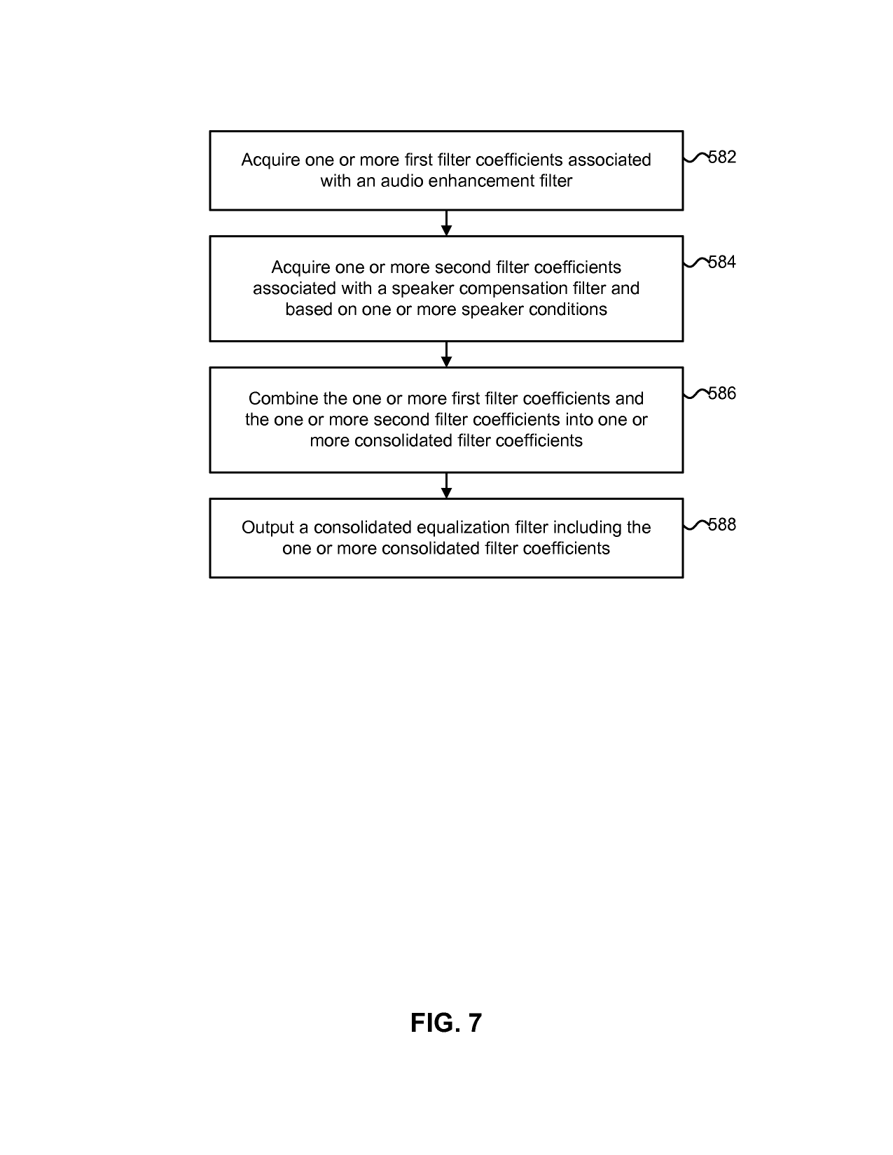

In step 516, a consolidated equalization filter is generated. In one embodiment, the consolidated equalization filter is generated using the audio enhancement filter created in step 510 and the speaker compensation filter created in step 514. The consolidated equalization filter may include a weighted combination of one or more audio enhancement coefficients and one or more speaker compensation coefficients. One embodiment of a process for generating a consolidated equalization filter is described later in reference to FIG. 7.

In step 518, an enhanced audio signal is generated using the consolidated equalization filter and the particular media file. In one embodiment, the enhanced audio signal may be generated by loading the consolidated equalization filter generated in step 516 into an audio signal processor or a digital signal processor (DSP) with equalization capability (e.g., the TAS3103 Digital Audio Processor from Texas Instruments). The enhanced audio signal may then be outputted to a digital to analog converter for conversion of the enhanced audio signal into an analog form for driving one or more speakers.

FIG. 6 is a flowchart describing one embodiment of a process for determining an audio category. The process described in FIG. 6 is one example of a process for implementing step 508 in FIG. 5. In one embodiment, the process of FIG. 6 is performed by an audio server, such as audio server 120 in FIG. 1.

In step 550, an audio file is acquired. In step 552, classification information associated with the audio file is acquired. The classification information may include a genre or other musical classification. The classification information may be acquired via metadata associated with the audio file. In step 554, an audio signal based on the audio file is generated. In some cases, the audio signal may comprise a decoded and streaming representation of the audio file. In step 556, one or more instrument sounds associated with one or more instruments are identified within the audio signal. In one embodiment, the one or more instruments may be identified by applying audio pattern matching techniques to the audio signal.

In step 558, it is determined whether an audio category exists corresponding with the classification information acquired in step 552 and the one or more instruments identified in step 556. If it is determined that the audio category already exists, then step 562 is performed. Otherwise, if it is determined that the audio category does not exist, then step 560 is performed. In step 560, the audio category and an audio enhancement filter for the audio category are created. In some cases, a new audio category may be created and added to an audio category database of audio categories and their corresponding audio enhancement filters. In one embodiment, the audio enhancement filter may be acquired from a media server, such as media server 160 and FIG. 1. In another embodiment, the audio enhancement filter may include one or more audio enhancement coefficients that are determined by interpolating coefficient values from a plurality of different audio enhancement filters associated with the one or more instruments identified in step 556. In step 562, the audio category is outputted.

FIG. 7 is a flowchart describing one embodiment of a process for generating a consolidated equalization filter. The process described in FIG. 7 is one example of a process for implementing step 516 in FIG. 5. In one embodiment, the process of FIG. 7 is performed by an audio server, such as audio server 120 in FIG. 1.

In step 582, one or more first filter coefficients associated with an audio enhancement filter are acquired. In step 584, one or more second filter coefficients associated with a speaker compensation filter are acquired. The one or more second filter coefficients may be adjusted based on one or more speaker conditions. In step 586, the one or more first filter coefficients and the one or more second filter coefficients are combined into one or more consolidated filter coefficients. In one embodiment, the one or more consolidated filter coefficients are generated using a weighted combination of the one or more first filter coefficients and the one or more second filter coefficients.

In some cases, if the number of one or more first filter coefficients is not equal to the number of one or more second filter coefficients or the center frequencies associated with the one or more first filter coefficients do not have a one to one correspondence with the one or more second filter coefficients (e.g., the one or more first filter coefficients are associated with 16 center frequencies and the one or more second filter coefficients are associated with 12 center frequencies), then an intermediary set of coefficients may be utilized. The intermediary set of coefficients may include the same number of coefficients as exists within the larger set of either the one or more first filter coefficients or the one or more second filter coefficients (i.e., the set with the largest number of coefficients determines the number of coefficients used for the intermediary set of coefficients). Each coefficient of the intermediary set of coefficients may be determined by interpolating new coefficients based on the smaller set of either the one or more first filter coefficients or the one or more second filter coefficients (i.e., the set with the smallest number of coefficients is remapped to include the same number of coefficients as the larger set with interpolated values). Subsequently, the one or more consolidated filter coefficients may be generated using a weighted combination of the intermediary set of coefficients and the larger set of either the one or more first filter coefficients or the one or more second filter coefficients.

In step 588, a consolidated equalization filter including the one or more consolidated filter coefficients generated in step 586 is outputted. The consolidated equalization filter allows an enhanced audio signal to be generated from an input audio signal (e.g., using an audio signal processor) in a single processing step.

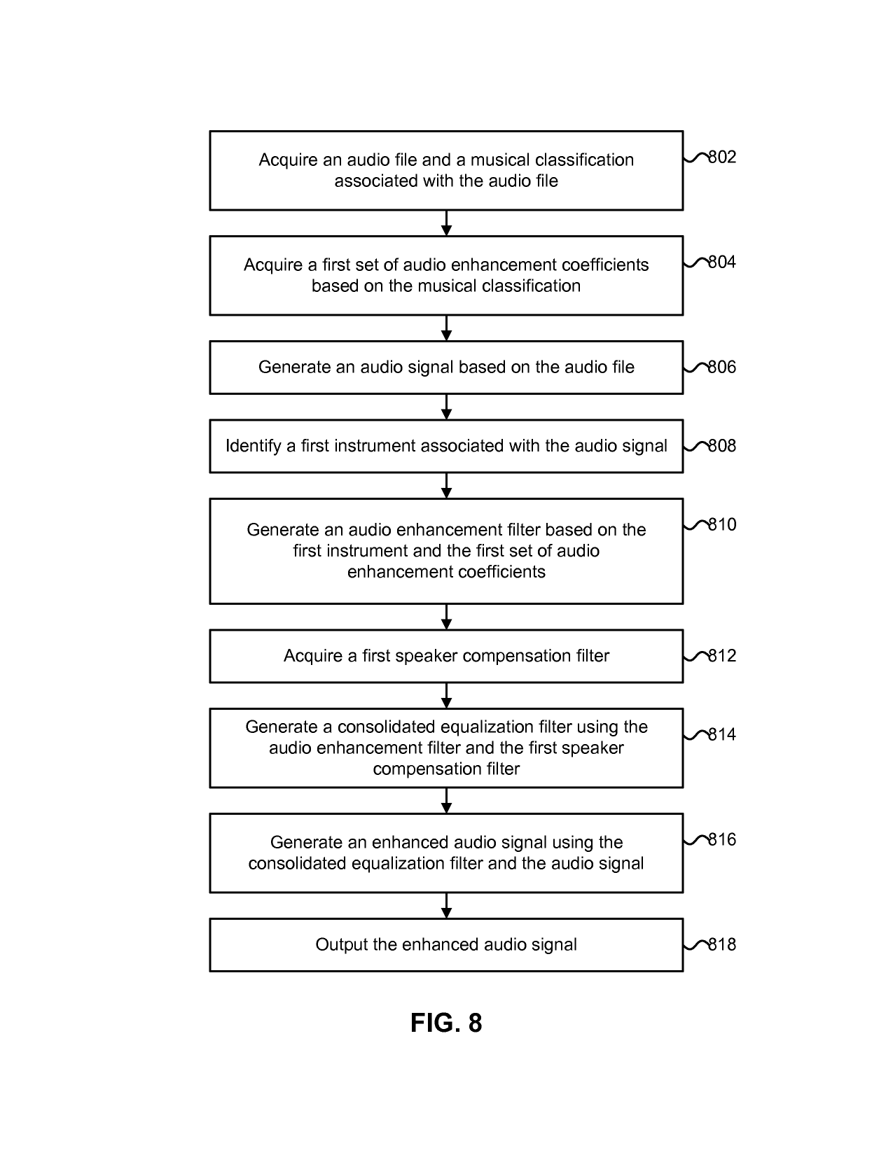

FIG. 8 is a flowchart describing an alternative embodiment of a process for generating an enhanced audio signal using a consolidated equalization filter. In one embodiment, the process of FIG. 8 is performed by an audio server, such as audio server 120 in FIG. 1.

In step 802, an audio file and a musical classification associated with the audio file is acquired. In step 804, a first set of audio enhancement coefficients based on the musical classification is acquired. In step 806, an audio signal based on the audio file is generated. In step 808, a first instrument associated with the audio signal is identified. In one embodiment, the first instrument may be identified by applying audio pattern matching techniques to the audio signal. The first instrument may be identified if sounds associated with the first instrument are detected within the audio signal.

In step 810, an audio enhancement filter is generated based on the first instrument and the first set of audio enhancement coefficients. In one embodiment, the audio enhancement filter includes one or more audio enhancement coefficients. The one or more audio enhancement coefficients may be determined using a weighted combination of the first set of audio enhancement coefficients and one or more instrument specific enhancement coefficients associated with the first instrument. The one or more instrument specific enhancement coefficients for enhancing the sounds of the first instrument may be acquired from an instrument profiles server. The media server 160 in FIG. 1 may serve as an instrument profiles server.

In step 812, a first speaker compensation filter is acquired. The first speaker compensation filter may be acquired from a speaker profiles server, such as speaker profiles server 162 in FIG. 1. In step 814, a consolidated equalization filter is generated. The consolidated equalization filter may be generated using the audio enhancement filter generated in step 810 and the first speaker compensation filter acquired in step 812. In step 816, an enhanced audio signal using the consolidated equalization filter and the audio signal is generated. The enhanced audio signal may be generated using an audio signal processing element with equalization capability and configured using the consolidated equalization filter. For example, the enhanced audio signal may be generated by loading the consolidated equalization filter generated in step 814 into an audio signal processor or a digital signal processor (DSP) with equalization capability (e.g., the TAS3103 Digital Audio Processor from Texas Instruments). In step 818, the enhanced audio signal is outputted. The enhanced audio signal may be outputted to a digital to analog converter for conversion of the enhanced audio signal into an analog form for driving one or more speakers.

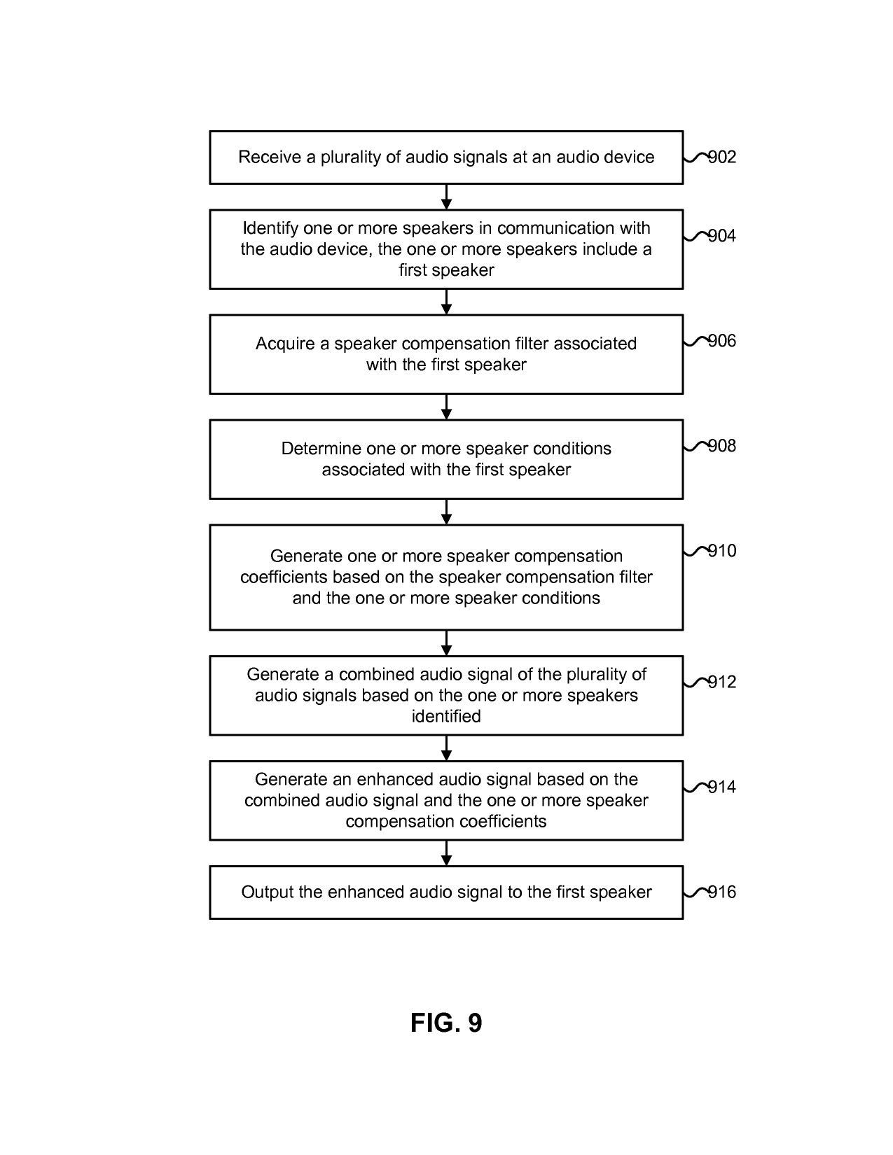

FIG. 9 is a flowchart describing one embodiment of a process for generating an enhanced audio signal based on the identification of one or more speakers in communication with an audio device. In one embodiment, the process of FIG. 9 is performed by a remote equalizer, such as remote equalizer 140 in FIG. 1. In another embodiment, the process of FIG. 9 is performed by an audio server, such as audio server 120 in FIG. 1.

In step 902, a plurality of audio signals is received at an audio device. The plurality of audio signals may be associated with a stereo audio recording. In step 904, one or more speakers in communication with the audio device are identified. The one or more speakers include a first speaker. In one embodiment, the one or more speakers are identified via a feedback channel from the one or more speakers to the audio device. In step 906, a speaker compensation filter associated with the first speaker is acquired. The speaker compensation filter may be acquired from a speaker profiles server, such as speaker profiles server 162 and FIG. 1.

In step 908, one or more speaker conditions associated with the first speaker are determined. The one or more speaker conditions may include temperature information associated with the first speaker, speaker lifetime information associated with the first speaker, or acoustic environment information associated with the first speaker (e.g., the first speaker exists in a large open space or in an enclosed car). In step 910, one or more speaker compensation coefficients are generated. The one or more speaker compensation coefficients may be generated based on the speaker compensation filter acquired in step 906 and the one or more speaker conditions determined in step 908.

In step 912, a combined audio signal of the plurality of audio signals received is generated. The combined audio signal may be generated based on the one or more speakers identified. In some cases, the combined audio signal may be generated based on the number of one or more speakers identified. For example, if the number of one or more speakers identified is one, then the plurality of audio signals may be combined into a single audio signal. In this case, if the plurality of audio signals comprises two channels associated with a stereo recording, then the combined audio signal will comprise a mono audio signal associated with the stereo recording.

In step 914, an enhanced audio signal is generated based on the combined audio signal and the one or more speaker compensation coefficients generated in step 910. In step 916, the enhanced audio signal is outputted to the first speaker.

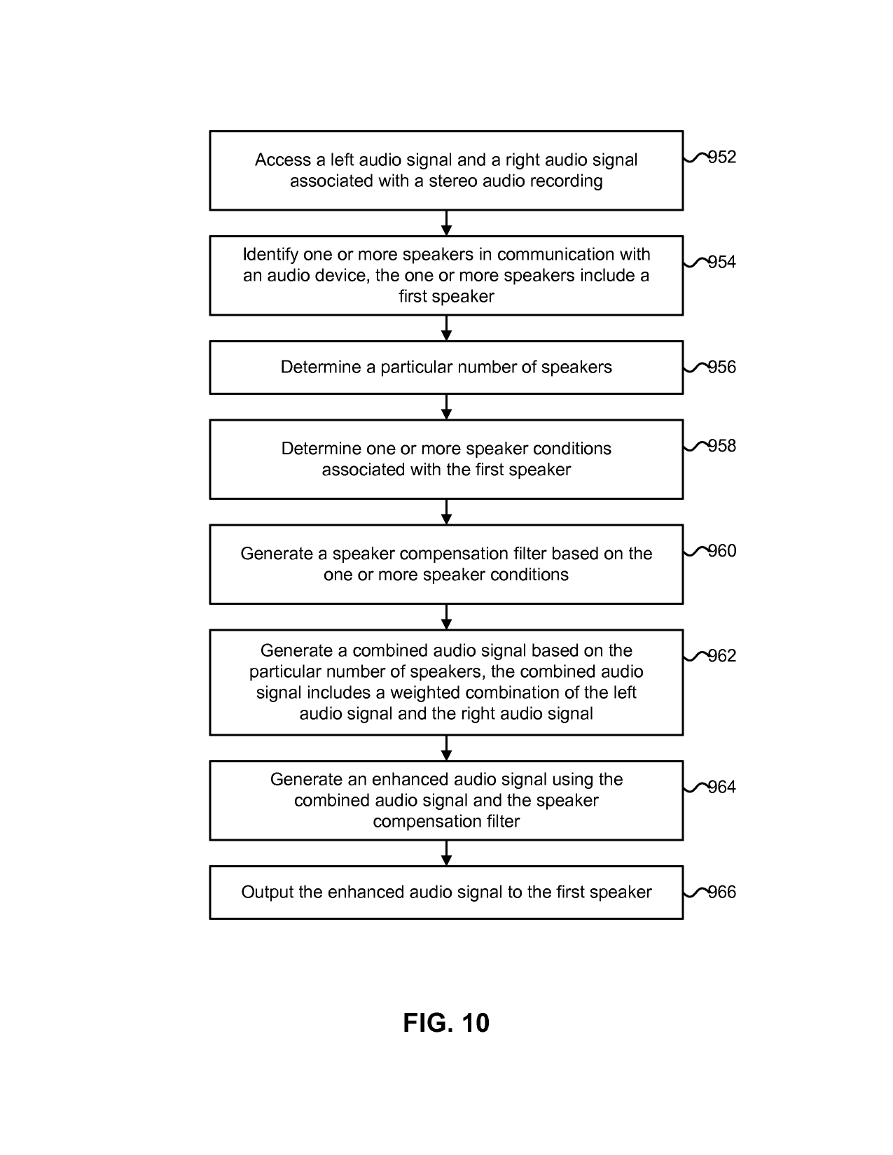

FIG. 10 is a flowchart describing another embodiment of a process for generating an enhanced audio signal based on the identification of one or more speakers in communication with an audio device. In one embodiment, the process of FIG. 10 is performed by a remote equalizer, such as remote equalizer 140 in FIG. 1. In another embodiment, the process of FIG. 10 is performed by an audio server, such as audio server 120 in FIG. 1.

In step 952, a left audio signal and a right audio signal associated with a stereo audio recording are accessed by an audio device. In step 954, one or more speakers in communication with an audio device are identified. The one or more speakers include a first speaker. In step 956, a particular number of speakers associated with the one or more speakers is determined. The particular number of speakers may be determined by identifying the number of one or more speaker in communication with the audio device. In step 958, one or more speaker conditions associated with the first speaker are determined.

In step 960, a speaker compensation filter based on the one or more speaker conditions is generated. In step 962, a combined audio signal is generated based on the particular number of speakers. In one embodiment, the combined audio signal may include a weighted combination of the left audio signal and the right audio signal if the particular number of speakers determined in step 956 is equal to one. In step 964, an enhanced audio signal is generated using the combined audio signal generated in step 962 and the speaker compensation filter generated in step 960. In step 966, the enhanced audio signal is outputted to the first speaker.

One embodiment of the disclosed technology includes determining a first set of audio output devices including a first speaker in communication with a music server, acquiring a particular media file, determining an audio category associated with the particular media file, creating an audio enhancement filter associated with the audio category, creating a speaker compensation filter associated with the first speaker, generating a consolidated equalization filter using the audio enhancement filter and the speaker compensation filter, generating an enhanced audio signal using the consolidated equalization filter and the particular media file, and outputting the enhanced audio signal.

One embodiment of the disclosed technology includes acquiring an audio file and a musical classification associated with the audio file, acquiring a first set of audio enhancement coefficients based on the musical classification, generating a left audio signal based on the audio file, identifying a first instrument associated with the left audio signal, generating a left audio enhancement filter based on the first instrument and the first set of audio enhancement coefficients, generating at the music server a left enhanced audio signal based on the left audio enhancement filter and the left audio signal, and outputting from the music server the left enhanced audio signal.

One embodiment of the disclosed technology includes a storage component and one or more processors in communication with the storage component. The storage component stores a particular audio file, one or more audio enhancement coefficients associated with a particular audio category, and one or more speaker compensation coefficients associated with a particular speaker. The one or more processors detect the particular speaker in communication with the one or more processors, determine that the particular audio file is associated with the particular audio category, generate a consolidated equalization filter using the one or more audio enhancement coefficients and the one or more speaker compensation coefficients, and generate an enhanced audio signal using the consolidated equalization filter and the particular audio file.

One embodiment of the disclosed technology includes receiving a plurality of audio signals at an audio device, identifying one or more speakers including a first speaker in communication with the audio device, acquiring a speaker compensation filter associated with the first speaker, generating one or more speaker compensation coefficients based on the speaker compensation filter, generating at the audio device a combined audio signal of the plurality of audio signals based on the one or more speakers identified, generating at the audio device an enhanced audio signal based on the combined audio signal and the one or more speaker compensation coefficients, and outputting the enhanced audio signal to the first speaker.

One embodiment of the disclosed technology includes accessing a left audio signal and a right audio signal associated with a stereo audio recording, identifying one or more speakers in communication with an audio device, the one or more speakers include a first speaker, generating a speaker compensation filter associated with the first speaker, and generating at the audio device a combined audio signal based on the one or more speaker identified. The combined audio signal includes a weighted combination of the left audio signal and the right audio signal. The method further includes generating at the audio device an enhanced audio signal using the combined audio signal and the speaker compensation filter and outputting the enhanced audio signal to the first speaker.

One embodiment of the disclosed technology includes a storage device and one or more processors in communication with the storage device. The storage device stores a speaker compensation filter associated with a first speaker. The one or more processors acquire a plurality of audio signals, identify one or more speakers including a first speaker in communication with an audio device, generate one or more speaker compensation coefficients based on the speaker compensation filter, generate a combined audio signal of the plurality of audio signals based on the one or more speakers identified, and generate an enhanced audio signal based on the combined audio signal and the one or more speaker compensation coefficients.

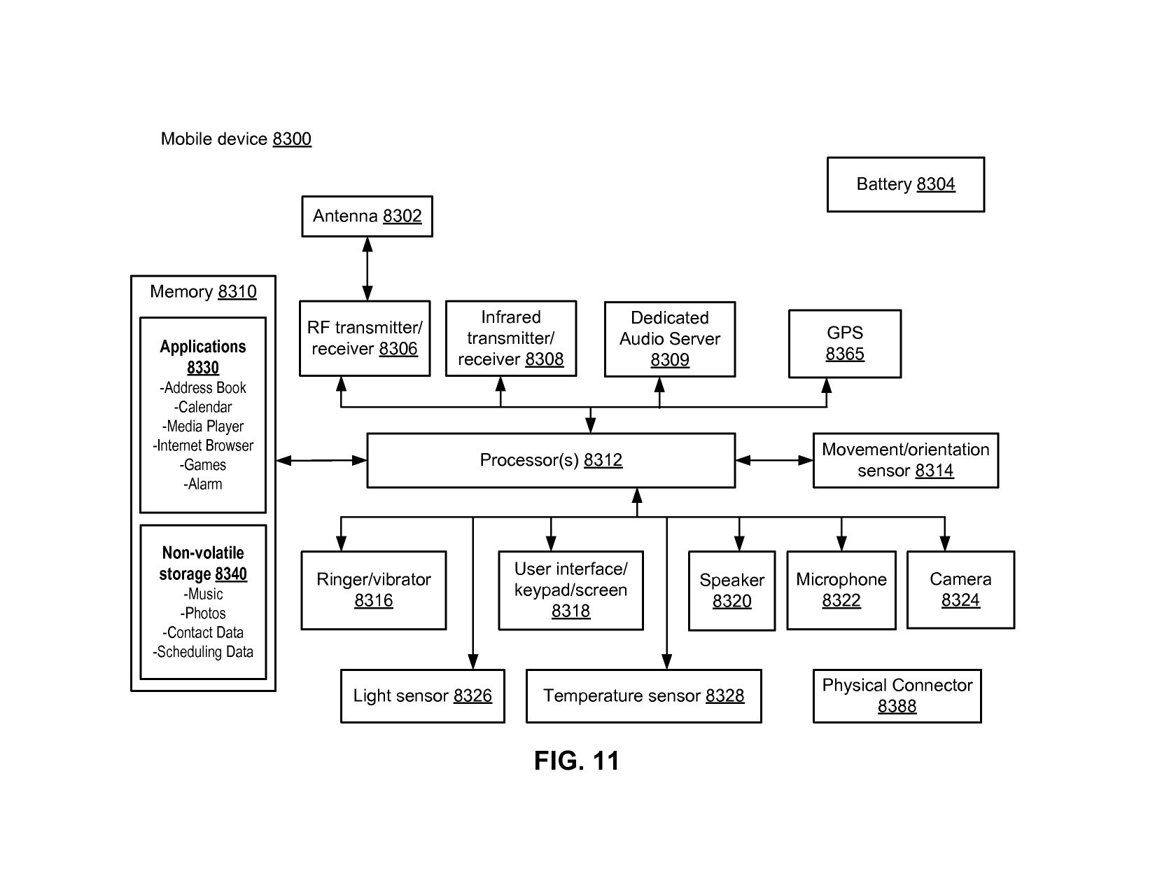

The disclosed technology may be used with various computing systems. FIG. 11 depicts one embodiment of a mobile device 8300, which includes one example of a mobile implementation for audio server 120 in FIG. 1. Mobile devices may include laptop computers, pocket computers, mobile phones, personal digital assistants, and handheld media devices that have been integrated with wireless receiver/transmitter technology.

Mobile device 8300 includes one or more processors 8312 and memory 8310. Memory 8310 includes applications 8330 and non-volatile storage 8340. Memory 8310 can be any variety of memory storage media types, including non-volatile and volatile memory. A mobile device operating system handles the different operations of the mobile device 8300 and may contain user interfaces for operations, such as placing and receiving phone calls, text messaging, checking voicemail, and the like. The applications 8330 can be any assortment of programs, such as a camera application for photos and/or videos, an address book, a calendar application, a media player, an internet browser, games, an alarm application, and other applications. The non-volatile storage component 8340 in memory 8310 may contain data such as music, photos, contact data, scheduling data, and other files.

The one or more processors 8312 also communicates with dedicated audio server 8309, with RF transmitter/receiver 8306 which in turn is coupled to an antenna 8302, with infrared transmitter/receiver 8308, with global positioning service (GPS) receiver 8365, and with movement/orientation sensor 8314 which may include an accelerometer and/or magnetometer. RF transmitter/receiver 8308 may enable wireless communication via various wireless technology standards such as Bluetooth® or the IEEE 802.11 standards. Accelerometers have been incorporated into mobile devices to enable applications such as intelligent user interface applications that let users input commands through gestures, and orientation applications which can automatically change the display from portrait to landscape when the mobile device is rotated. An accelerometer can be provided, e.g., by a micro-electromechanical system (MEMS) which is a tiny mechanical device (of micrometer dimensions) built onto a semiconductor chip. Acceleration direction, as well as orientation, vibration, and shock can be sensed. The one or more processors 8312 further communicate with a ringer/vibrator 8316, a user interface keypad/screen 8318, a speaker 8320, a microphone 8322, a camera 8324, a light sensor 8326, and a temperature sensor 8328. The user interface keypad/screen may include a touch-sensitive screen display.

The one or more processors 8312 controls transmission and reception of wireless signals. During a transmission mode, the one or more processors 8312 provide voice signals from microphone 8322, or other data signals, to the RF transmitter/receiver 8306. The transmitter/receiver 8306 transmits the signals through the antenna 8302. The ringer/vibrator 8316 is used to signal an incoming call, text message, calendar reminder, alarm clock reminder, or other notification to the user. During a receiving mode, the RF transmitter/receiver 8306 receives a voice signal or data signal from a remote station through the antenna 8302. A received voice signal is provided to the speaker 8320 while other received data signals are processed appropriately.

Additionally, a physical connector 8388 may be used to connect the mobile device 8300 to an external power source, such as an AC adapter or powered docking station, in order to recharge battery 8304. The physical connector 8388 may also be used as a data connection to an external computing device. The data connection allows for operations such as synchronizing mobile device data with the computing data on another device.

For purposes of this document, each process associated with the disclosed technology may be performed continuously and by one or more computing devices. Each step in a process may be performed by the same or different computing devices as those used in other steps, and each step need not necessarily be performed by a single computing device.

For purposes of this document, reference in the specification to “an embodiment,” “one embodiment,” “some embodiments,” or “another embodiment” are used to described different embodiments and do not necessarily refer to the same embodiment.

For purposes of this document, a connection can be a direct connection or an indirect connection (e.g., via another part).

For purposes of this document, the term “set” of objects, refers to a “set” of one or more of the objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for operating an audio device, comprising:
receiving a plurality of audio signals at the audio device;
identifying one or more speakers in communication with the audio device, the one or more speakers include a first speaker;
acquiring a speaker compensation filter associated with the first speaker;
generating at the audio device a combined audio signal of the plurality of audio signals based on the one or more speakers identified;
generating at the audio device an enhanced audio signal based on the combined audio signal and the speaker compensation filter; and
outputting the enhanced audio signal to the first speaker.

2. The method of claim 1, further comprising:
adjusting one or more speaker compensation coefficients, the speaker compensation filter includes the one or more speaker compensation coefficients, the adjusting one or more speaker compensation coefficients is performed prior to the generating an enhanced audio signal.

3. The method of claim 2, further comprising:
determining one or more speaker conditions associated with the first speaker, the one or more speaker conditions include a temperature associated with the first speaker, the adjusting one or more speaker compensation coefficients includes adjusting the one or more speaker compensation coefficients based on the one or more speaker conditions.

4. The method of claim 2, further comprising:
determining one or more speaker conditions associated with the first speaker, the one or more speaker conditions include a speaker lifetime associated with the first speaker, the adjusting one or more speaker compensation coefficients includes adjusting the one or more speaker compensation coefficients based on the one or more speaker conditions.

5. The method of claim 1, further comprising:
acquiring a second speaker compensation filter associated with a second speaker of the one or more speakers;
generating at the audio device a second enhanced audio signal based on the combined audio signal and the second speaker compensation filter; and
outputting the second enhanced audio signal to the second speaker.

6. The method of claim 1, wherein:
the plurality of audio signals is associated with a stereo audio recording;
the one or more speakers are connected together in a daisy chain configuration; and
the combined audio signal includes a weighted combination of the plurality of audio signals.

7. The method of claim 2, further comprising:
acquiring one or more environmental conditions associated with the first speaker, the one or more environmental conditions include an identification of the room acoustics associated with the first speaker, the adjusting one or more speaker compensation coefficients includes adjusting the one or more speaker compensation coefficients based on the one or more environmental conditions.

8. The method of claim 1, wherein:
the identifying one or more speakers includes acquiring an identification of the first speaker from the first speaker.

9. The method of claim 1, wherein:
the generating an enhanced audio signal includes providing the speaker compensation filter to an audio signal processor.

10. The method of claim 9, wherein:
the audio signal processor generates the enhanced audio signal by performing equalization on the combined audio signal using the speaker compensation filter.

11. A method for operating an audio device, comprising:
accessing a left audio signal and a right audio signal associated with a multichannel audio recording;
identifying one or more speakers in communication with the audio device, the one or more speakers include a first speaker;
generating a speaker compensation filter associated with the first speaker;
generating at the audio device a combined audio signal based on the one or more speakers identified, the combined audio signal includes a weighted combination of the left audio signal and the right audio signal;
generating at the audio device an enhanced audio signal using the combined audio signal and the speaker compensation filter; and
outputting the enhanced audio signal to the first speaker.

12. The method of claim 11, further comprising:
determining a particular number of speakers associated with the one or more speakers, the generating a combined audio signal includes generating the combined audio signal based on the particular number of speakers.

13. The method of claim 11, further comprising:
determining one or more speaker conditions associated with the first speaker, the one or more speaker conditions include a temperature associated with the first speaker, the generating a speaker compensation filter includes generating one or more speaker compensation coefficients of the speaker compensation filter based on the one or more speaker conditions.

14. The method of claim 11, further comprising:
determining one or more speaker conditions associated with the first speaker, the one or more speaker conditions include a speaker lifetime associated with the first speaker, the generating a speaker compensation filter includes generating one or more speaker compensation coefficients of the speaker compensation filter based on the one or more speaker conditions.

15. The method of claim 11, further comprising:
acquiring one or more environmental conditions associated with the first speaker, the one or more environmental conditions include an identification of the room acoustics associated with the first speaker, the generating a speaker compensation filter includes generating one or more speaker compensation coefficients of the speaker compensation filter based on the one or more environmental conditions.

16. The method of claim 11, wherein:
the generating an enhanced audio signal includes providing the speaker compensation filter to an audio signal processor; and
the left audio signal and the right audio signal comprise two separate channels associated with the multichannel audio recording.

17. The method of claim 16, wherein:
the audio signal processor generates the enhanced audio signal by performing equalization on the combined audio signal using the speaker compensation filter.

18. An audio device, comprising:
a storage device, the storage device stores a speaker compensation filter associated with a first speaker; and
one or more processors in communication with the storage device, the one or more processors acquire a plurality of audio signals, the one or more processors identify one or more speakers in communication with the audio device, the one or more speakers include the first speaker, the one or more processors generate one or more speaker compensation coefficients based on the speaker compensation filter, the one or more processors generate a combined audio signal of the plurality of audio signals based on the one or more speakers identified, the one or more processors generate an enhanced audio signal based on the combined audio signal and the one or more speaker compensation coefficients.

19. The audio device of claim 18, further comprising:
a temperature sensor, the one or more processors acquire temperature information from the temperature sensor; and
the one or more processors generate the one or more speaker compensation coefficients based on the speaker compensation filter and the temperature information.

20. The audio device of claim 18, wherein:
the one or more processors acquire speaker lifetime information associated with the first speaker, the one or more processors generate the one or more speaker compensation coefficients based on the speaker compensation filter and the speaker lifetime information.
